(19) United States
(12) Patent Application Publication
(10) Pub. No.: US 2024/0415079 A1
(43) Pub. Date: Dec. 19, 2024

(54) Controllable Dripper Valve and System Thereof

(71) Applicant: The State Of Israel, Ministry of Agriculture & Rural Development, Agricultural Research Organization, Rishon Lezion (IL)

(72) Inventors: Victor ALCHANATIS, Mazkeret Batya (IL); Raphael LINKER, Eshchar (IL); Shay YULZARY, Hod Hasharon (IL)

(21) Appl. No.: 18/698,559

(22) PCT Filed: Oct. 2, 2022
(86) PCT No.: PCT/IL2022/051047

§ 371 Date: Apr. 4, 2024

Related U.S. Application Data
(60) Provisional application No. 63/252,403, filed on Oct. 5, 2021.

(51) Int. Cl. A01G 25/02; F16K 31/08

(52) U.S. Cl. CPC A01G 25/023; F16K 31/082

(57) ABSTRACT

A controllable valve unit and corresponding irrigation system are described. The controllable valve is configured for use with an irrigation dripper positioned along an irrigation line. The controllable valve unit is configured to be selectively shiftable between a first open position and a second closed position to selectively control flow of irrigation therethrough. The controllable valve unit comprises at least one magnet, enabling switching of said valve between said first open and said second closed positioned by selective application of magnetic field in its surroundings.

### TECHNOLOGICAL FIELD

The present disclosure relates to irrigation system, and specifically to controllable irrigation system enabling selective irrigation levels at selected regions of a field.

### BACKGROUND

Various agricultural irrigation systems are based on irrigation lines with integrated drippers. Both water and nutrients may sometimes be supplied through these drippers. Such drippers can be placed along irrigation lines and provide an aperture for water to exit the irrigation line at a selected or predetermined flow rate.

### GENERAL DESCRIPTION

The current conventional dripper technology is generally mature and well proven. However, the existing technology lacks the ability to precisely control flow rates through dippers along a line. More specifically, the existing techniques enable installing additional drippers where high irrigation in needed, and less drippers where plant require lower amount of water. However, the flow control is generally limited to entire length of irrigation line, with limited control at each specific position.

There is a need in the art for a novel technique for irrigation control, enabling selective water and nutrients supply for different locations along an irrigation line. The present technique provides a controllable dripper unit, and controllable valve unit, enabling direct control over localized flow rate through each individual dripper unit.

The controllable dripper utilizes controllable valve that is generally passive. More specifically, the controllable valve is stable at each selected position while generally not requiring power supply to maintain its position. Further, the controllable valve is configured to enable remote switching, and can be installed without any additional changes to the irrigation system. Position or status of the controllable valve may be switched by applying external field on the valve, causing it to switch between open and closed positions. For example, the controllable valve unit may be configured to switch between open and closed positions in response to external magnetic field applied thereto. This enables a generally remote control over irrigation levels at selected positions along an irrigation line.

In this connection, the controllable valve of the present disclosure comprises a mechanism providing two or more distinct valve states. Such two or more states can be defined as “open” and “closed”, and one or more intermediate states when used. The valve mechanism is designed to be stable it each of the two or more states, such that no external energy is required to hold it in either state. Further, the valve is responsive to selected external field, to thereby shift the valve from one state to another in accordance with the external field.

According to some embodiments of the present disclosure, the controllable valve may utilize one or more magnets connected to respective one or more sealing arrangements within a housing. The one or more magnets used to enable the valve mechanism to be responsive to external field and apply translational force shifting the one or more sealing arrangements between the respective states of the valve.

Generally, the controllable valve may utilize one or more ferromagnetic elements located at selected positions to thereby hold the valve mechanism in the selected one or more states thereof. When in selected proximity, the one or more magnets induce magnetic dipoles in the respective ferromagnetic elements, causing attractive force that keeps the valve mechanism in its selected state, dictating flow rate through the valve.

As indicated above, the controllable valve can be actuated to shift between the two or more states by applying selected external field thereon. More specifically, external magnetic field applied on the valve, generates force that operates on the one or more magnets of the valve. Such magnetic force, being attracting or repelling, is selected to overcome force between the magnet and the respective ferromagnetic element, extracting the valve mechanism from the current stable position and shifting it to a further stable state position.

In this connection, the present disclosure also provides a valve actuation unit, configured to selectively actuate one or more valve as described herein to shift between valve states. Accordingly, the valve actuation unit is configured to selectively apply magnetic field in one or more directions, such that when operated within certain vicinity to a controllable valve, the magnetic field applied on the valve caused the valve mechanism to shift between stated. The valve actuation unit may include one or more electromagnets, user interface for controlling polarity of the electromagnet, and comprise, or be connectable to a power source providing electrical power to operate the one or more electromagnets. Alternatively, the actuation unit may include a permanent magnet and selected mount or shielding configured to enable selective variation of magnetic field around the permanent magnet.

The actuation unit is configured to enable selective variation of valve state by applying magnetic field of selected direction and polarity in vicinity of a selected valve. Accordingly, the actuation unit does not require any contact with the valve, and may operate within selected proximity, e.g., a few millimeters to a few centimeters, to provide sufficient magnitude of the magnetic field and actuate shifting of the valve mechanism from one end position to another.

Generally, the controllable valve of the present disclosure may be used for various applications. In some applications, the controllable valve may be integrated within a dripper, to enable selective control over dripper flow between at least two states including high-flow state (or open state) and low-flow state (or closed state). Integration of the controllable valve typically does not require any changes in the dripper's operating principle or basic structure. The flow rate in each valve state can be predetermined by design, so that the “open” position can represent maximum flow rate and the “closed” position can enable partial flow or no flow. The valve is located downstream of the dripper's pressure reduction mechanism (e.g., dripper labyrinth) enabling reduction of pressure from the valve, such that it does not need to hold the full line pressure in full or partial flow states.

Additionally, in some embodiments, the controllable valve may comprise a valve position detection unit. The valve position detection unit may be integrated within the controllable valve itself, or in the respective dripper. The valve position detection unit enables automatic detection of the valve state, between “open” or “closed” states, or intermediate states if used. This allows detection of valve state prior to switching operation (to determine its current state) or after switching (to verify that the valve has actually arrived at its desired new position). The valve position detection unit may comprise one or more RF transmission circuits positioned and configured to vary response signal thereof in accordance with state of the valve mechanism. For example, the RF transmission circuit may be formed of a coil circuit integrated within the valve or the dripper, such that the coil is positioned to around one or more of the one or more magnets. This configuration provides that position of the respective one or more magnets with respect to the circuit affects the circuit's electrical properties.

Additionally, in some configurations, the valve or its respective dripper may also comprise an RF antenna. The RF antenna allows communication with an external reader device. An external device with appropriate RF antenna is used to energize and interrogate the valve circuit and detect its position. The detection can be done remotely without the need for direct contact between the external device and the internal circuit.

Thus, according to a broad aspect, the present disclosure provides a controllable valve unit configured to be positioned along an irrigation line, said controllable valve unit is configured to be selectively shiftable between a first open position and a second closed position thereby selectively controlling flow of irrigation therethrough, wherein said controllable valve unit comprises at least one magnet, thereby enabling switching of said valve between said first open and said second closed positioned by selective application of magnetic field in its surroundings.

According to some embodiments, said at least one magnet may be associated with a seal and is moveable within a housing between said first open position, wherein said seal is shifted away from path of flow through said housing to allow a first flow rate through said valve, and said second closed position, where said seal is moved into path of flow through said housing to allow a second different flow rate through said valve.

According to some embodiments, said controllable valve unit may be configured to be placed downstream of a pressure reduction mechanism, thereby eliminating a need for holding full pressure by said valve unit.

According to some embodiments, the controllable valve unit may further comprise an electronic circuit configured to transmit backscattering radiation in response to input radiation of a selected frequency, said electronic circuit comprises an RFID circuit configured to transmit a first response signal when said valve unit is in a first open position and a second response signal when said valve unit is in a second closed position.

According to some embodiments, said electronic circuit may comprise at least one electrically conducting coil section positioned in path of said at least one magnet providing a first inductance characteristics when said valve is in a first open position and a second inductance characteristic when said valve is in said second closed position.

According to some embodiments, said electronic circuit may comprise at least one reed switch configured to connect at least one electronic component, thereby varying impedance of said circuit when said valve is in said second closed position and to disconnect said at least one electronic component when said valve is in said first open position.

According to some embodiments, said at least one electronic component may be at least one of capacitor inductor and resistor.

According to some embodiments, said controllable valve unit may be configured as a two-state plunger valve, said two-state plunger valve comprises a shuttle carrying said at least one magnet and being configured to traverse between said first open position and said second closed position.

According to some embodiments, said shuttle may be held fixed in a selected position by friction, and selectively moveable in response to external magnetic field applied thereto. Additionally, or alternatively, the shuttle may be held in a selected position by magnetic attraction, the controllable valve may comprise at least first and second paramagnetic or ferromagnetic elements positioned in vicinity of first and second fixed positions of said shuttle, generating magnetic attraction with said at least one magnet thereby fixing said shuttle in position.

According to some embodiments, said controllable valve unit may be configured as a bi-stable shuttle valve, said bi-stable shuttle valve comprises a shuttle mounted on a flexible mechanism configured to traverse between tow mechanically stable positions, said flexible mechanism carrying said at least one magnet and being configured maintain position within one of said tow mechanically stable positions and shift between said positioned in response to external magnetic field.

According to some embodiments, said controllable valve unit may maintain its positions for a predetermined period while not requiring power supply input.

According to one other broad aspect, the present disclosure provides an irrigation dripper unit comprising a pressure reduction mechanism, a dripping aperture and a controllable valve positioned along flow line between the pressure reduction mechanism and the dripping aperture; said controllable valve comprises a moveable sealing member moveable between at least a first open position and a second closed position; wherein said moveable sealing member carries at least one permanent magnet, thereby enabling selective shifting of said sealing member between said first open position and a second closed position by external magnetic field.

According to some embodiments, the irrigation dripper unit may further comprise an electronic circuit configured to transmit backscattering radiation in response to input radiation of a selected frequency, said electronic circuit comprises an RFID circuit configured to transmit a first response signal when said valve unit is in a first open position and a second response signal when said valve unit is in a second closed position.

According to some embodiments, said electronic circuit may comprise at least one electrically conducting coil section positioned in path of said at least one magnet providing a first inductance characteristics when said valve is in a first open position and a second inductance characteristic when said valve is in said second closed position.

According to some embodiments, said electronic circuit may comprise at least one reed switch configured to connect at least one electronic component, thereby varying impedance of said circuit when said valve is in said second closed position and to disconnect said at least one electronic component when said valve is in said first open position.

According to some embodiments, said at least one electronic component may be at least one of capacitor inductor and resistor.

According to some embodiments, said controllable valve may be configured as a two-state plunger valve, said sealing member is mounted on a shuttle carrying said at least one permanent magnet and being configured to traverse between said first open position and said second closed position.

According to some embodiments, said shuttle is held fixed in a selected position by friction, and selectively moveable in response to external magnetic field applied thereto.

According to some embodiments, said controllable valve may comprise at least first and second ferromagnetic elements positioned for magnetically interacting with said permanent magnet, thereby holding said two-state plunger in either said first open position or said second closed position.

According to yet another broad aspect, the present disclosure provides a controllable valve unit for controlling fluid flow rate therethrough, the controllable valve unit comprises a housing, an input connector for accepting input flow, an output aperture for outputting flow, and a moveable plunger; said moveable plunger is formed of at least one permanent magnet and is moveable between a first position defining a first effective fluid aperture, and a second position defining a second effective fluid aperture, different than the first effective fluid aperture.

According to some embodiments, said housing comprises at least first and second paramagnetic or ferromagnetic elements, said first paramagnetic or ferromagnetic elements positioned to be magnetized and attract said at least one permanent magnet in said first position of the moveable plunger, said second paramagnetic or ferromagnetic elements is positioned to be magnetized and attract said at least one permanent magnet in said second position of the moveable plunger.

According to some embodiments, the controllable valve may further comprise a bistable spring mechanism mounting said moveable plunger.

Generally, according to yet a further aspect, the controllable valve of the present disclosure as described herein may be used in a cascade of controllable valves having selected one or more different first and second flow rates associated with open and closed states of each valve. Such cascade of controllable valves may be used for providing controllable selected flow rate forming a plurality of flow rates selected by arrangement of valves states along such cascade.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A and 1B illustrate a first example of controllable valve unit according to some embodiments of the present disclosure in first and second plunger positions;

FIGS. 2A and 2B illustrate a second example of controllable valve unit according to some embodiments of the present disclosure in first and second plunger positions;

FIGS. 3A and 3B illustrate a further example controllable valve unit according to some embodiments of the present disclosure in external and transparent view;

FIGS. 4A to 4C schematically illustrate a position indication circuit according to Some embodiments of the present disclosure, FIG. 4A shows RFID based position indication circuit, FIG. 4B shows position indication circuit using capacitor switching, and FIG. 4C exemplifies a Reed switch;

FIG. 5 exemplifies a magnetic field generators suitable for switching state of operation of a controllable valve unit according to some embodiments of the present disclosure;

FIG. 6 illustrates a valve actuation system including a magnetic field generator according to some embodiments of the present disclosure; and

FIG. 7 illustrates operation of shifting valve state between open and closed state.

### DETAILED DESCRIPTION OF EMBODIMENTS

As indicated above, the present disclosure provides a controllable valve unit, configured to selectively allow fluid transmission in two or more flow states. The controllable valve unit may be configured to be associated with a liquid flow line such as irrigation line, and may be associated with a dripper unit, e.g., downstream of dripper mechanism such as labyrinth, for controlling irrigation level at each point along the irrigation line.

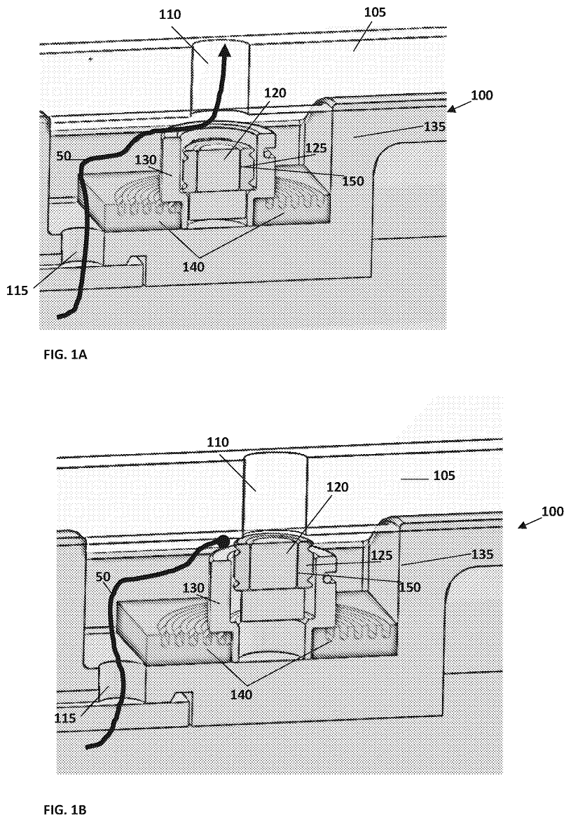

A controllable valve unit configured to be positioned along an irrigation line, said controllable valve unit is configured to be selectively shiftable between a first open position and a second closed position thereby selectively controlling flow of irrigation therethrough. Reference is made to FIGS. 1A and 1B illustrating an exemplary configuration of a controllable valve mechanism 100 according to some embodiments of the present disclosure. FIG. 1A illustrates the valve in an open position and FIG. 1B illustrates the valve in a closed position. As shown, the controllable valve includes an input aperture 115 and output aperture 110 defined as apertures in valve chassis formed by first 135 and second 105 sections of valve frame. The Valve itself includes a seal or gasket 125 positioned on a permanent magnet 120 moveable within a guide 130. The magnet 120 and gasket 125 arrangement is moveable along the guide 130 such that at a first position illustrated in FIG. 1A, the gasket leaves output aperture 110 free allowing flow of fluid 50 to go through output aperture. FIG. 1B shows magnet 120 and gasket 125 arrangement is a second position, generally blocking fluid access to output aperture 110, resulting is valve being closed to fluid flow 50. Generally, the controllable valve 100 is configured to provide a first effective fluid aperture in a first position of the magnet and gasket arrangement (e.g., as illustrated in FIG. 1A) and a second effective fluid aperture in a second position of the magnet and gasket arrangement (e.g., as illustrated in FIG. 1B). the first and second effective fluid apertures have respective first and second effective area, allowing respective first and second flow rates, thereby controlling flow rate of fluids through the valve 100. In this connection, the magnet and gasket arrangement are hereby referred to as plunger 150, having a first position providing first flow rate and a second position providing a second flow rate different (and generally smaller) than the first flow rate.

The valve frame, e.g., formed of first and second frame portions 135 and 105, typically includes at least first and second ferromagnetic or paramagnetic elements positioned in vicinity of first and second positions of plunger 150. For example, the first and second frame portions 135 and 105 may be formed of a magnetic material or include magnetic regions in vicinity of first and second positions of plunger 150. The ferromagnetic or paramagnetic elements are magnetized by magnet 120 in accordance with distance between them and generate attraction between magnet 120 and the closest magnetic element of the frame. This attraction results in the first and second positions of plunger 150 to be stable, maintaining the valve unit 100 in its state until suitable external magnetic field shifts the plunger 150 between positions. Thus, the controllable valve unit 100 is passive to maintain in a selected state and requires external magnetic field to shift between states. This enables the controllable valve to operate without any need for continuous external power maintaining its state unless shifted purposely.

As indicated above, the valve 100 provide first and second effective apertures for fluid flow. Generally, the varying aperture may be an input aperture 115 or output aperture 110 of the valve in accordance with design selection. Further, the aperture area (of effective diameter) may be selected to allow proper irrigation water flow, typically including one or more fertilizers or other materials dissolved in the water. In some embodiments, the valve may be configured to allow flow of any selected fluid, and its dimensions are selected to provide desired flow characteristics.

Also, as illustrated in FIGS. 1A and 1B, the controllable valve 100 may include a position detector providing indication of valve state. In FIGS. 1A and 1B position indicator is exemplified by position indication circuit 140. The circuit 140 is in the form of an electrically conducting coil, connected to an RF repeater circuit. The coil is positioned around plunger 150 such the variation in plunger location between first and second positions, changes electrical properties of the coil, thereby varying frequency or amplitude of an outgoing RF repeater signal. Accordingly, status of the valve unit can be detected using an RF reader circuit responsive to response signal of the position detector.

In some embodiments of the present disclosure, position detector may be formed by a window indicating position of the plunger. For example, one or more selected points on the plunger may be painted with a bright color (e.g., red) while one or more other points may be painted by a different bright color (e.g., green). The valve chassis 105 and/or 135 may include a window located to face a first color region when the plunger is in a first position and a second color region when the plunger is in a second position, thereby providing indication on valve status.

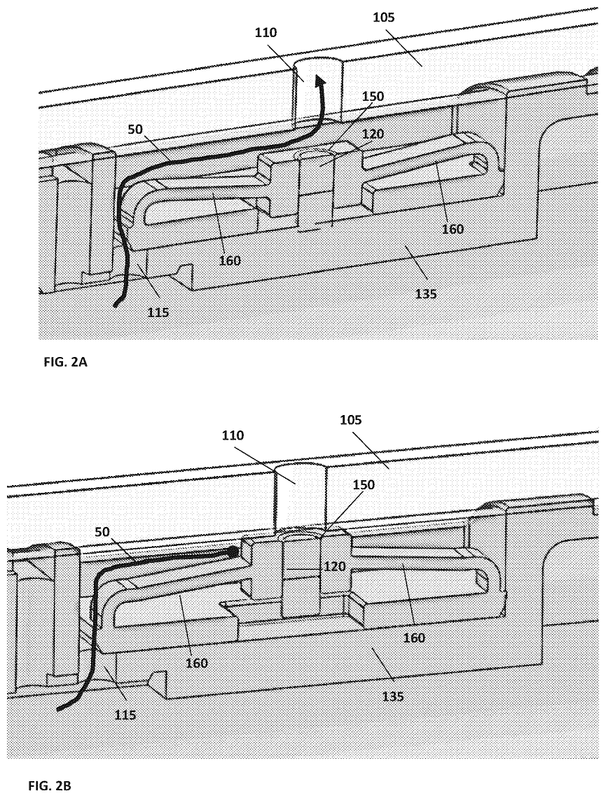

An additional configuration of the controllable valve unit according to some embodiments of the present disclosure is illustrated in FIGS. 2A and 2B. In this exemplary configuration, the plunger 150, carrying one or more magnetic elements 120 is held stable in either one of the first and second positions thereof using a bistable spring mechanism 160. Here, FIG. 2A illustrates the valve with plunger 150 configured as a shuttle mounted on a bistable spring 160 and positioned in a first open position, allowing fluid flow 50 from input aperture 115 through open volume of the valve chassis and out of the output aperture 110. FIG. 2B shows the same valve in a second, closed state, where the plunger 150 is placed to block fluid flow 50 throughout the exit aperture 110. To enable shifting the plunger position remotely, the plunger includes one or more permanent magnetic elements 120 that may be formed of a selected ferromagnetic material carrying permanent magnetic dipole in a selected direction.

The plunger is held in place in either one of a first and a second positions by a bistable spring 160. In this example, bistable spring 160 is exemplified by two spring leaves having dimensions and elasticity providing two stable positions that require certain force to switch between the positions. As indicated above, an external magnetic field having suitable direction and field amplitude, may be used to apply force to the permanent magnet 120 of the plunger 150 and shift the plunger 150 between positions and switch the valve between first (open) and second (closed) states. In this configuration, such external magnetic field applies force on the permanent magnet 120 of plunger 150 to extract the plunger from a stable position defined by bistable spring elements 160. Once the plunger overcomes spring 160 force to maintain stable position, the spring 160 pulls the plunger to a second stable position and maintains this position.

Also, as indicated above, the plunger position may be selected to block exit aperture 110 and/or input aperture 115, or any selected position along fluid flow 50 through cavity of the valve. Also as indicated above, the first and second positions of plunger 150 generally relate to first and second effective aperture area affecting flow rate of fluid between high (open) flow, and low (closed) flow. However, it should be noted that the closed state by be selected to allow a selected flow rate, generally lower than flow rate allowed in the first (open) state of the valve.

The valve unit described above may be placed in any selected location along an irrigation line. In some examples, the valve unit may be configured as a part of a dripper unit, providing dripping irrigation at a selected location. Thus, the valve may be a standalone unit having at least one connector for liquid input, and at least one output that may be in the form of an aperture allowing fluing flow outside of the piping, e.g., to water planets, or a connector, allowing further flow of the fluid to selected location. Generally, the inventors have found that it may be preferable to place the controllable valve downstream with respect to a dripper labyrinth, thereby reducing flow pressure in the valve and allowing the controllable valve to selectively allow first or second flow rates, without the need to hold on fluid pressure.

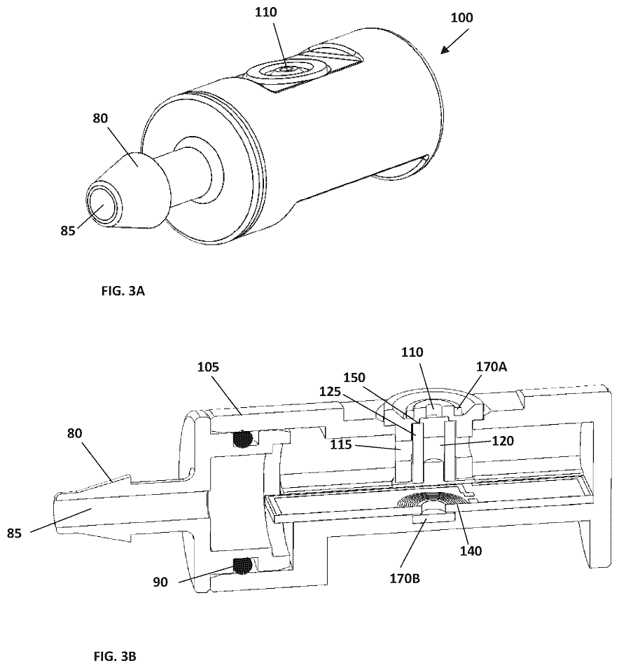

In this connection, reference is made to FIGS. 3A and 3B illustrating a controllable valve unit according to some embodiments of the present disclosure. FIG. 3A exemplifies an external view of the valve 100, and FIG. 3B illustrates an example of internal elements of the valve. As shown, the valve 100 is placed inside a closed chassis having a pipe connector 80 providing an input port 85 to accept fluid and an output aperture 110 for releasing fluid. Generally, output port 110 may be configured to allow direct connection to additional piping for directing fluid to a selected location or configured to release fluids from the valve as illustrated in FIGS. 3A and 3B. The valve chassis may be formed of main chassis section 105 and connection plug 80 including a sealing member (e.g., sealing ring) 90 between them.

FIG. 3B illustrates an exemplary internal structure of controllable valve 100. As indicated above, the valve mechanism includes a plunger 150 formed by at least a sealing element 125 and at least one permanent magnet 120 (e.g., rare earth metal magnet such as neodymium magnet). The plunger 150 is configured to move between a first position providing first flow aperture for liquid flow between mechanism input aperture 115 and output aperture 110, and a second position providing second flow aperture, which is generally smaller than the first flow aperture. As indicated above, the first and second positions of plunger 150 determine open and closed flow rates through the valve. The valve mechanism also includes at least first and second paramagnetic or ferromagnetic members 170A and 170B positioned to maintain the plunger in either one of first and second positions utilizing magnetic attraction between the permanent magnet 120 of the plunger and member 170A or 170B depending on plunger position.

Also illustrated in FIG. 3B is plunger location circuit 140. The location circuit 140 is formed as a passive RF repeater circuit (e.g., RFID circuit) having at least one coil section positioned to be generate first interface characteristics with permanent magnet 120 when plunger is in a first position, and second interface characteristics with permanent magnet 120 when plunger 150 is in second position. More specifically, plunger location circuit 140 may include a coil section, positioned such that is a first position of plunger 150, permanent magnet 120 is located in close proximity to the coil section, and in a second position of the plunger, the permanent magnet 120 is further from coil section (or vice versa). This variation in distance between permanent magnet 120 and coil section of the circuit 140 is selected to vary inductance characteristics of circuit 140 and thereby vary RF response transmitted thereby in response to interrogating RF signal. This configuration enables a user/operator to remotely determine plunger 150 position, and accordingly determine valve operation status.

It should be noted that plunger position circuit 140 may utilize various other configurations. For example, certain configurations may utilize variation in capacitance though out the circuit in response to variation of position of the plunger 150. Alternatively, the plunger location circuit may include a portion of plunger 150 for transmission electrical current therethrough, where changes in plunger position varies path or material through which the electrical current is transmitted, thereby varying electrical resistance of the circuit 140.

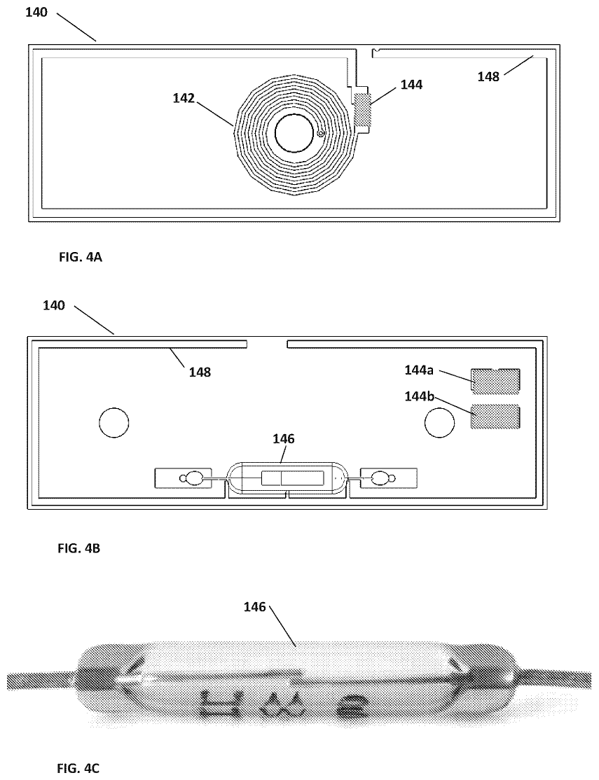

Thus, the controllable valve of the present disclosure enables at least first and second flow rate, where cascade of controllable valves, or a valve comprising a cascade of moveable plunger mechanisms may enable selection between a plurality of flow rates. As described above, the controllable valve unit may include a position indication circuit 140. Although the position indication circuit 140 is exemplified above in the form of an electrically conducting coil, such circuit may be implemented in various techniques. Reference if made to FIGS. 4A to 4C exemplifying a elements of circuit configuration according to some embodiments of the present disclosure. FIG. 4A illustrates an RFID-based position indication circuit 140 including an inductance coil 142 and a capacitor, FIG. 4B shows a second perspective of the RFID-based position indication circuit 140 showing two different capacitors 144a and 144b and a switching mechanism 146, and FIG. 4C illustrates the switch 146.

Generally, the RFID-based position indication circuit may be formed as a passive RFID tag including an antenna 148 configured to collect energy from scanning signal, and to transmit tag information in response to a scanning signal. The tag information may be determined by electrical parameters of the RFID circuit and may thus be determined by one or more electrical elements of the circuit. Accordingly, the position indication circuit 140 may include a switch 146 configured to switch between two electronic elements (e.g., capacitors 144a and 144b) in accordance with state of plunger of the valve unit. The two electronic elements have different electrical parameters, resulting in variation of reply signal transmitted by the RFID antenna 148 in response to interrogating signal. For example, capacitors 144a and 144b may be configured with different capacitance, thereby varying impedance of the RFID circuit, and its resonance frequency indicating one or more parameters in the RFID response ID.

To provide small size switch that does not require external energy source for operation, the position indication circuit 140 may utilize Reed, or Reed-type, switch 146. An example of Reed switch 146 is illustrated in FIG. 4C. As shown, the switch is formed of two electrically conducting leaves, generally placed within a vacuum, or low pressure, tube. The leaves are flexibly elastic and configured not to touch in typical conditions. However, in presence of magnetic field or selected magnitude, the leaves are magnetized and attract each other, thereby closing a circuit. The switch may be configured to be open circuit when the plunger is in a first position, away from the switch. When the plunger is in a second position, closer to the switch, the permanent magnet of the plunger applies magnetic field around the switch 146 and causes closing of the circuit, thereby varying electrical properties of RFID circuit and accordingly the response ID thereof to indicate plunger position.

Thus, the controllable valve may utilize various configurations of the position indication circuit 140 providing remote indication on position of plunger 150 and state of the valve unit. Such position indication circuit 140 configurations may utilize magnetic properties of the permanent magnet 120 of plunger 150 to vary response signal of a RF repeater circuit, to allow an operator to obtain indication of valve status without the need to physically inspect the valve and/or flow rate therethrough. This allows an operator to remotely verify valve status and modify it if needed.

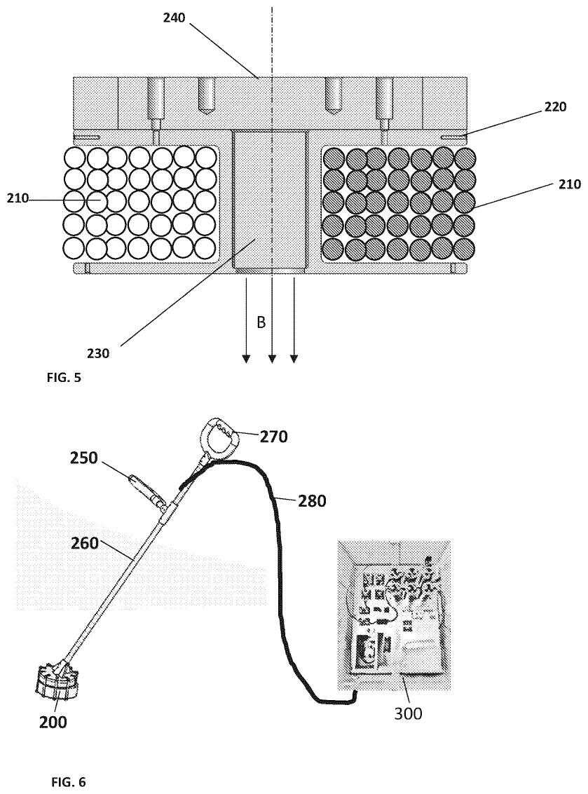

The use of permanent magnet 120 in plunger 150 enables applying external force on the plunger by providing external magnetic field around the valve unit. To this end the present disclosure also provides a valve controlling unit configured to enable an operator to selectively switch state of the controllable valve described herein. The valve controlling unit is generally a mobile magnetic field generator configured to selectively generate magnetic field in two or more directions. The valve controlling unit may be a hand-held unit or configured to be mounted on a vehicle. To thereby enable an operator to selectively switch between operation states of different controllable valves located in different places in a field. The valve controller may typically utilize an electromagnetic unit configured to selective generate magnetic field in two opposite directions, thereby enabling to switch valve state from first state to second state and from second state to first state. Reference is made to FIG. 5 exemplifying a magnetic field generator 200 configured as an electromagnet utilizing a coil of electrically conducting wire 210. The coil of electrically conducting wire 210 may include a selected number of windings, selected to generate a desired magnetic field amplitude using selected electrical current. The coil wire 210 may be wrapped around a ferromagnetic core 230 to enhance magnetic field amplitude, and may include a rear protection plate 240, e.g., formed also of a ferromagnetic material, configured, and positioned to reduce magnetic field directed toward the operator of the controller, while enhancing magnetic field at a downward side of the generator 200. Typically, the wire 210 may be wind around a drum 220 configured to hold the wire in place.

When the magnetic field generator 200 is located in selected vicinity of a controllable valve 100, the magnetic field generate force pulling (or pushing) the permanent magnet of the plunger to shift location of the plunger and switch the valve from a first state to a second state. Using a switch configured to direct electrical current through wire 210 in a first or second direction, an operator can apply magnetic field in a selected direction or turn magnetic field off to preserve energy when away from valves that need to be switched.

An example of valve actuation system is illustrated in FIG. 6. The valve actuation system includes a magnetic field generator 200, typically mounted on a mount 260, e.g., long hand-held mount, having a handle 270 and user interface 250 including one or more switches for operating the magnetic field generator between off, first direction and second direction modes. The magnetic field generator 200 may be connected to a power source and control unit 300 using power transmission cable 280.

Generally, in some embodiments, the valve actuation system may also include an RFID reader unit. The RFID reader unit may be placed at a bottom end of the actuation system, e.g., in vicinity of magnetic field generator. The RFID reader may be configured to transmit interrogation signal and be responding to response signal indicating state of a controllable valve, and to generate respective data and present it to an operator via user interface 250. The valve status may be presented in the form of a LED light indication two colors (green-open, red-closed) or by language indication (i.e., open or closed) etc. In accordance with valve status, the operator may determine if valve status needs to be changes and operate magnetic field generator accordingly. After applying external magnetic field, the operator may than operate RFID reader to read valve status again in order to verify that valve status changed successfully and proceed to other valves in the field. This allows an operator to adjust flow rate in various places used a plurality of controllable valves in simple operation as described herein.

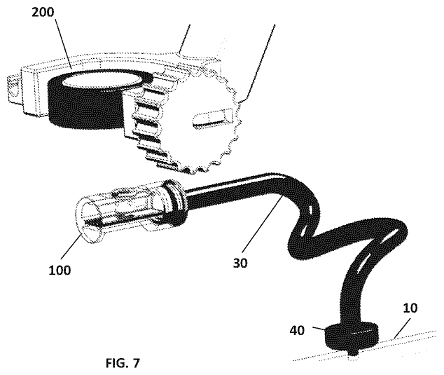

The operation of changing valve state is exemplified in FIG. 7. Here, a controllable valve unit 100 is connected to an irrigation line 10 using a dripper connector 40 and short pipe section 30. The valve may preferably be placed in a selected orientation, e.g., allowing the plunger to move up and down, to simplify valve state switching operation. To change valve state, a magnetic field generator 200 is placed in a selected vicinity of the valve 100 and operated to apply magnetic field in either one of up or down directions. For example, magnetic field in up direction may operate to apply upward force on the permanent magnet of the plunger and downward magnetic field may operate to apply downward force on the permanent magnet of the plunger. The force applied to the permanent magnet shifts the plunger accordingly and switches the valve between first (open) and second (closed) states, thereby varying flow rate through the valve. As indicated above, the flow rate may be shifted from a selected high flow rate to full stop. In some other embodiments, the flow rate may be shifted from a selected high flow rate to a selected other, slower flow rate. Selection of the flow rate variation between states is determined by variation of effective aperture area of the valve in the first and second states.

Thus, the present disclosure provides a controllable valve unit and valve actuation system. The valve unit allows for controlling selected flow rate of fluid (e.g., irrigation water) in selected positions along a flow line. The present technique enables simple and cheap method for controlling flow rate locally and adjusting the selected flow rate in accordance with various requirements, such as variation in vegetation and plants growth between seasons and allows for adjusting flow rate selectively to optimize plant growth.

It should be noted that the various features described in the various embodiments can be combined according to all possible technical combinations. It should also be understood that the present invention is not limited in its application to the details set forth in the description contained herein or illustrated in the drawings. The invention is capable of other embodiments and being practiced and carried out in various ways. Hence, it is to be understood that the phraseology and terminology employed herein are for the purpose of description and should not be regarded as limiting. As such, those skilled in the art will appreciate that the conception upon which this disclosure is based can readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1. A controllable valve unit configured to be positioned along an irrigation line, said controllable valve unit is configured to be selectively shiftable between a first open position and a second closed position thereby selectively controlling flow of irrigation therethrough, wherein said controllable valve unit comprises at least one magnet, thereby enabling switching of said valve between said first open and said second closed positioned by selective application of magnetic field in its surroundings.

2. The controllable valve unit of claim 1, wherein said at least one magnet is associated with a seal and is moveable within a housing between said first open position, wherein said seal is shifted away from path of flow through said housing to allow a first flow rate through said valve, and said second closed position, where said seal is moved into path of flow through said housing to allow a second different flow rate through said valve.

3. The controllable valve unit of claim 1, wherein said controllable valve unit is configured to be placed downstream of a pressure reduction mechanism, thereby eliminating a need for holding full pressure by said valve unit.

4. The controllable valve unit of claim 1, further comprising an electronic circuit configured to transmit backscattering radiation in response to input radiation of a selected frequency, said electronic circuit comprises an RFID circuit configured to transmit a first response signal when said valve unit is in a first open position and a second response signal when said valve unit is in a second closed position.

5. The controllable valve unit of claim 4, wherein said electronic circuit comprises at least one electrically conducting coil section positioned in path of said at least one magnet providing a first inductance characteristics when said valve is in a first open position and a second inductance characteristic when said valve is in said second closed position.

6. The controllable valve unit of claim 4, wherein said electronic circuit comprises at least one reed switch configured to connect at least one electronic component, thereby varying impedance of said circuit when said valve is in said second closed position and to disconnect said at least one electronic component when said valve is in said first open position.

7. The controllable valve unit of claim 6 wherein said at least one electronic component is at least one of capacitor inductor and resistor.

8. The controllable valve unit of claim 1, wherein said controllable valve unit is configured as a two-state plunger valve, said two-state plunger valve comprises a shuttle carrying said at least one magnet and being configured to traverse between said first open position and said second closed position.

9. The controllable valve unit of claim 8, wherein said shuttle is held fixed in a selected position by friction, and selectively moveable in response to external magnetic field applied thereto.

10. The controllable valve unit of claim 1, wherein said controllable valve unit is configured as a bi-stable shuttle valve, said bi-stable shuttle valve comprises a shuttle mounted on a flexible mechanism configured to traverse between tow mechanically stable positions, said flexible mechanism carrying said at least one magnet and being configured maintain position within one of said tow mechanically stable positions and shift between said positioned in response to external magnetic field.

11. The controllable valve unit of claim 1, wherein said controllable valve unit maintains its positions for a predetermined period while not requiring power supply input.

12. An irrigation dripper unit comprising a pressure reduction mechanism, a dripping aperture and a controllable valve positioned along flow line between the pressure reduction mechanism and the dripping aperture; said controllable valve comprises a moveable sealing member moveable between at least a first open position and a second closed position; wherein said moveable sealing member carries at least one permanent magnet, thereby enabling selective shifting of said sealing member between said first open position and a second closed position by external magnetic field.

13. The irrigation dripper unit of claim 12, further comprising an electronic circuit configured to transmit backscattering radiation in response to input radiation of a selected frequency, said electronic circuit comprises an RFID circuit configured to transmit a first response signal when said valve unit is in a first open position and a second response signal when said valve unit is in a second closed position.

14. The irrigation dripper unit of claim 13, wherein said electronic circuit comprises at least one electrically conducting coil section positioned in path of said at least one magnet providing a first inductance characteristics when said valve is in a first open position and a second inductance characteristic when said valve is in said second closed position.

15. The irrigation dripper unit of claim 14, wherein said electronic circuit comprises at least one reed switch configured to connect at least one electronic component, thereby varying impedance of said circuit when said valve is in said second closed position and to disconnect said at least one electronic component when said valve is in said first open position.

16. The irrigation dripper unit of claim 15 wherein said at least one electronic component is at least one of capacitor inductor and resistor.

17. The irrigation dripper unit of claim 12, wherein said controllable valve is configured as a two-state plunger valve, said sealing member is mounted on a shuttle carrying said at least one permanent magnet and being configured to traverse between said first open position and said second closed position.

18. The irrigation dripper unit of claim 17, wherein said shuttle is held fixed in a selected position by friction, and selectively moveable in response to external magnetic field applied thereto.

19. The irrigation dripper unit of claim 17, wherein said controllable valve comprises at least first and second ferromagnetic elements positioned for magnetically interacting with said permanent magnet, thereby holding said two-state plunger in either said first open position or said second closed position.

20. A controllable valve unit for controlling fluid flow rate therethrough, the controllable valve unit comprises a housing, an input connector for accepting input flow, an output aperture for outputting flow, and a moveable plunger; said moveable plunger is formed of at least one permanent magnet and is moveable between a first position defining a first effective fluid aperture, and a second position defining a second effective fluid aperture, different than the first effective fluid aperture.

21-22. (canceled)
